(19) United States
(12) Patent Application Publication
(10) Pub. No.: US 2009/0265273 A1
(43) Pub. Date: Oct. 22, 2009

(54) Transaction authorization

(75) Inventors: Vishwam Guntupalli, Khammam (IN); Siva Prasad Babu Madeneni, Andhra Pradesh (IN)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 12/148,454

(22) Filed: Apr. 18, 2008

(51) Int. Cl. G06Q 40/00

(52) U.S. Cl. 705/44

(57) ABSTRACT

A transaction authorization method and system. The system includes a host coupled to a plurality of transaction request channels (telephone, PC, and the like) for receiving and authorizing transaction requests for a specific self-service terminal. The system also includes a self-service terminal coupled to the host for receiving a transaction message therefrom. The transaction message includes a transaction identifier and a customer identifier, so that the self-service terminal is operable to provide a customer with a transaction amount from the transaction identifier in response to the customer entering details matching the contents of the customer identifier.

### FIELD OF INVENTION

The present invention relates to transaction authorization. The invention is related, but in no way limited, to transaction authorization at a self-service terminal (SST).

### BACKGROUND

SSTs are public access devices that are suitable for allowing a customer to conduct a transaction or to access information in an unassisted manner and/or in an unattended environment.

Common examples of SSTs include automated teller machines (ATMs), information kiosks, financial services centers, bill payment kiosks, lottery kiosks, postal services machines, check-in and check-out terminals such as those used in the hotel, car rental, and airline industries, retail self-checkout terminals, vending machines, and the like.

A particularly important example of an SST is an automated teller machine (ATM). ATMs allow customers to perform financial transactions, such as cash withdrawal transactions. Such cash withdrawal transactions typically require the customer to insert a card and enter an associated personal identification number (PIN) to authenticate himself/herself. The PIN is authenticated at a host, which also confirms whether the customer has sufficient funds to cover the cash withdrawal request.

### SUMMARY OF THE INVENTION

Accordingly, the invention generally provides methods, systems, apparatus, and software for transaction authorization at a self-service terminal to enable a customer to obtain authorization for a transaction prior to executing the transaction at the self-service terminal.

In addition to Summary of Invention provided above and the subject matter disclosed below in the Detailed Description, the following paragraphs of this section are intended to provide further basis for alternative claim language for possible use during prosecution of this application, if required. If this application is granted, some aspects of the invention may relate to claims added during prosecution of this application, other aspects may relate to claims deleted during prosecution, other aspects may relate to subject matter never claimed. Furthermore, the various aspects detailed hereinafter are independent of each other, except where stated otherwise. Any claim corresponding to one aspect should not be construed as incorporating any element or feature of the other aspects unless explicitly stated in that claim.

According to a first aspect there may be provided a transaction authorization method implemented by a self-service terminal, the method comprising: receiving a transaction message from a host, the transaction message including a transaction identification field, a customer verification field, and a transaction amount field; storing the received transaction message as an entry in a pending transaction list; receiving a transaction code and a customer code from a customer; matching the received transaction code and the received customer code with an entry in the pending transaction list; and providing the customer with the amount from the transaction amount field of the matched entry from the pending transaction list.

The step of storing the received transaction message as an entry in a pending transaction list may include the further step of storing the received transaction for a predefined time and then deleting that entry if not executed prior to expiry of the predefined time. For increased security, the predefined time may be relatively short, for example, one hour, two hours, or the like. When the self-service terminal deletes that entry because of expiry of the predefined time, the self-service terminal may send a message to the host indicating that the transaction was not executed.

The step of providing the customer with the amount from the transaction amount field may include dispensing the amount to the customer in physical cash, in electronic cash, in valuable media to the value of the transaction amount (for example, a cheque for that amount), or the like.

The method may comprise the further step of transmitting a transaction fulfilled message to the host subsequent to the step of providing the customer with the amount from the transaction amount field.

According to a second aspect there may be provided a computer program for a self-service terminal, the computer program being operable, when executed on a self-service terminal, to implement the method of the first aspect.

The computer program may be embodied on a tangible medium, executed in memory, propagated as a signal, or the like.

According to a third aspect there may be provided a transaction authorization method comprising: receiving a transaction request from a customer entered at a device other than a self-service terminal, the request including a transaction amount and a self-service terminal identification; verifying that the transaction request fulfils an acceptance criterion; and transmitting a transaction message to a self-service terminal corresponding to the self-service terminal identification so that the self-service terminal is operable to execute a transaction using only the transaction message and information entered by the customer.

The method may comprise the further steps of: storing the transaction message in a pending transaction store; and deleting the transaction message from the pending transaction store in response to receipt of a transaction fulfilled message from the self-service terminal.

The step of receiving a transaction request from a customer may be implemented via any convenient channel. For example, the transaction request may be received via the Internet, an interactive voice response (IVR) system, a text messaging system (such as SMS), electronic mail, or the like.

The acceptance criterion may include any convenient authorization mechanism. For example, the acceptance criterion may include: comparing a password received from the customer with a stored password for that customer; comparing a PIN received from the customer with a stored PIN for that customer; comparing a telephone number (landline or cellular) to a stored telephone number for that customer; comparing answers to one or more questions supplied by the customer to stored answers previously supplied by that customer.

The host may be used to authenticate customers from multiple channels; for example, Internet, telephone, text messaging, teller in a branch, or the like.

The acceptance criterion may also include verifying account details; for example, verifying that the transaction amount is less than an amount available for withdrawal from an account of the customer.

The method may comprise the further step of debiting the customer's account by an amount equal to the transaction amount. The step of debiting the customer's account may be performed when the transaction request is received, when the transaction fulfilled message is received, or at any other convenient time.

According to a fourth aspect there may be provided a computer program for a transaction authorization host, the computer program being operable, when executed on the transaction authorization host, to implement the method of the third aspect.

According to a fifth aspect there may be provided a system for authenticating transactions at a self-service terminal, the system comprising: a host coupled to a plurality of transaction request channels for receiving and authorizing transaction requests for a specific self-service terminal; a self-service terminal coupled to the host for receiving a transaction message therefrom, the transaction message including a transaction identifier and a customer identifier, so that the self-service terminal is operable to provide a customer with a transaction amount from the transaction identifier in response to the customer entering details matching the contents of the customer identifier.

The transaction identifier may comprise a transaction identifier field (which may include a code to identify a specific transaction) and a transaction amount field.

The customer identifier may comprise a customer identifier field, which may include a code to identify a specific customer.

### BRIEF DESCRIPTION OF THE DRAWINGS

These and other aspects will be apparent from the following specific description, given by way of example, with reference to the accompanying drawings, in which:

FIG. 1 is a block diagram of a transaction authorization system according to one embodiment of the present invention;

FIG. 2 is a flowchart describing the steps involved in requesting authorization of a transaction using the system of FIG. 1;

FIG. 3 is a pictorial diagram illustrating a Web page presented to a customer to enable the customer to request authorization of a transaction using the system of FIG. 1;

FIG. 4, which is a flowchart illustrating the steps performed by a part of the transaction authorization system (a transaction host) in response to a customer request for authorization of a transaction; and

FIG. 5 is a flowchart describing the steps performed by another part of the transaction authorization system (a self-service terminal) to fulfill an authorized transaction.

### DETAILED DESCRIPTION

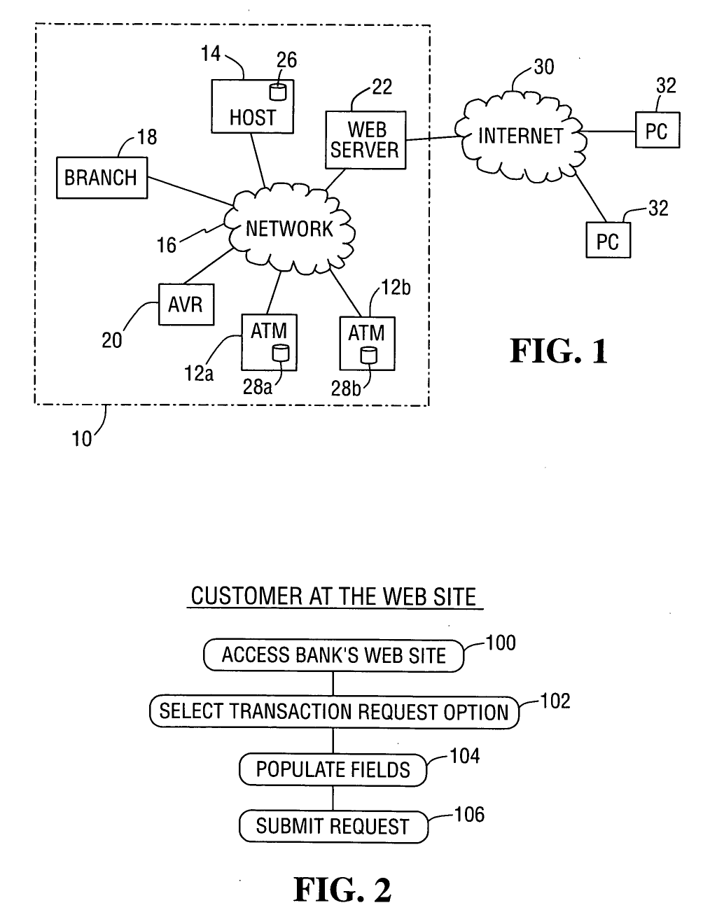

Reference will now be made to FIG. 1, which is a block diagram of a transaction authorization system 10 according to one embodiment of the present invention. The system 10 comprises a plurality of ATMs 12 (for clarity only two of which, 12a and 12b, are shown in FIG. 1) coupled to a transaction authorization host 14 by a private network 16. The system 10 also comprises a branch 18, an interactive voice response (IVR) system 20, and a Web server 22, all of which are coupled to the private network 16. The branch 18 may include a plurality of teller stations, each coupled to the host 14 by the private network 16. The host 14 includes a pending transaction store 26, and the ATMs 12 each contain a pending transaction list 28, as will be described in more detail to below.

The Web server 22 is also coupled to the Internet 30 to allow customers to access banking information, such as information about their current balance, recent transactions, and the like, via a personal computer 32 (again, for clarity, only two PCs 32 are shown).

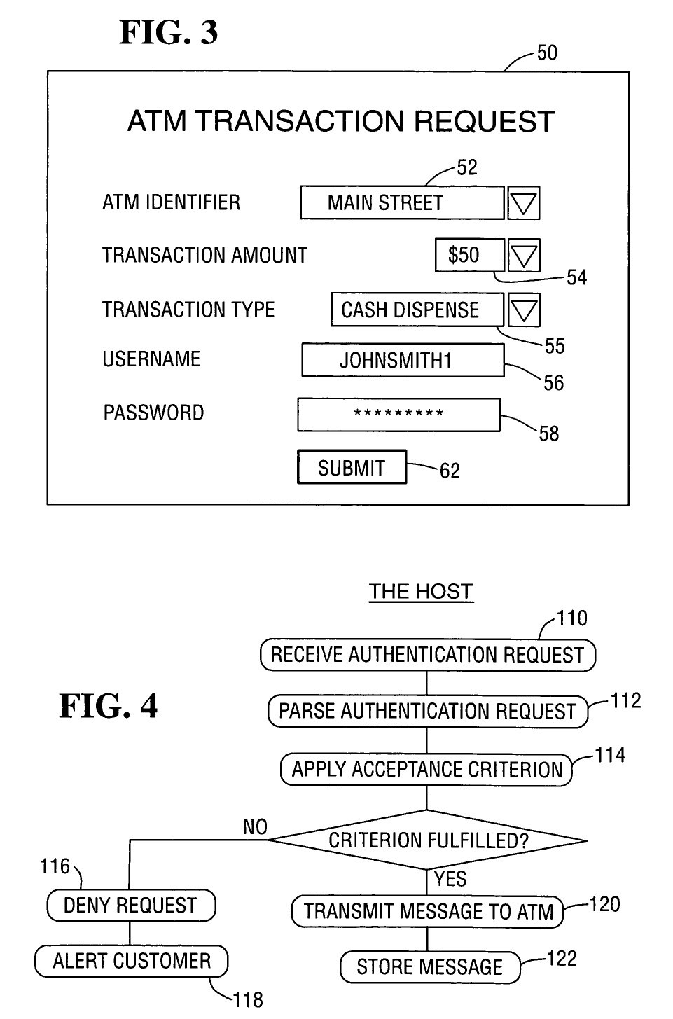

As illustrated in FIG. 1, a customer can access account information using a secure channel, such as a PC 32, a telephone (via the IVR system 20), or at the branch 18. The customer can use any of these secure channels to request authorization of a transaction. In this example, the customer uses a PC 32 to make the authorization request, as Will now be described with reference to FIGS. 2 and 3. FIG. 2 is a flowchart illustrating the steps implemented by an ATM customer to request authorization of a transaction at one of the ATMs 12b. FIG. 3 is a pictorial view of a Web page presented to the customer.

Initially, the customer accesses his/her bank's Web site (step 100) and selects an option to request authorization of a transaction (step 102). The Web site then provides a Web page 50 having a plurality of fields for completion by the customer, as illustrated in FIG. 3. These fields include an ATM identification field 52, a transaction amount field 54, a transaction type field 55 (if needed), a username field 56, and a password field 58 (although the customer may already have entered his/her username and password to reach this Web page).

The ATM identification field 52 is a drop-down list that identifies ATMs by the location of the ATM, for example, an address (20 Main Street) or a retail location (within a named department store). The Web page 50 may allow the customer to replace the address of an ATM in the drop-down list with his/her own label, to enable the customer to select the desired ATM (for example, “ATM near my office”). In this example, the customer selects ATM 12b.

The transaction amount field 54 allows the customer to enter the amount of money to be dispensed. In this example, the customer selects fifty U.S. dollars ($50).

The username field 56 and password field 58 allow the customer to enter his/her Web site username and password that he/she uses to access that Web site.

The customer then completes these fields 52 to 58 (step 104), and submits the request (step 106) to the Web server 22 by clicking on the “Submit” button 62.

The Web server 22 responds by confirming receipt of the request and providing the customer with a transaction code. In this example, the transaction code provided is “12345”.

The operation of the host 14 will now be described with reference to FIG. 4, which is a flowchart illustrating the steps performed by the host 14 in response to the Web server 22 forwarding the transaction request entered by the customer.

Initially, the host 14 receives the transaction request (step 110), and parses the received request (step 112) to ascertain which customer account is being referenced and the details of the transaction requested (in this example, withdrawal of fifty dollars).

The host 14 then applies an acceptance criterion (step 114). In this example, the acceptance criterion comprises (i) comparing the password entered in field 58 with the password registered for that username to ensure that they match, and (ii) confirming that the customer has sufficient funds in his/her account to meet the withdrawal request (in this example, fifty dollars).

If the acceptance criterion is not fulfilled, then the host 14 denies the request (step 116) and sends a message to the customer (for example, by email, text message, and/or by placing a message for that customer on the customer's Web page 50) to alert the customer to this failed transaction request (step 118).

If the acceptance criterion is fulfilled, then the host 14 transmits a pending transaction message to the ATM identified in the ATM identification field 52 (in this example, ATM 12b) (step 120). The pending transaction message comprises a transaction identification field, a customer verification field, a transaction amount field, and a lifetime field.

The transaction identification field includes the transaction code provided to the customer.

The customer verification field includes a code assigned to the customer, which may be a PIN or a PIN offset—for convenience, both a PIN and a PIN offset will be referred to herein as a PIN.

The transaction amount field includes data indicating that fifty dollars is to be withdrawn.

The lifetime field includes a time at which the transaction will expire, in this example, one day after the customer sent the transaction authorization request.

The host 14 then creates an entry for the pending transaction message in the pending transaction store 26 (see FIG. 1) within the host 14 (step 122).

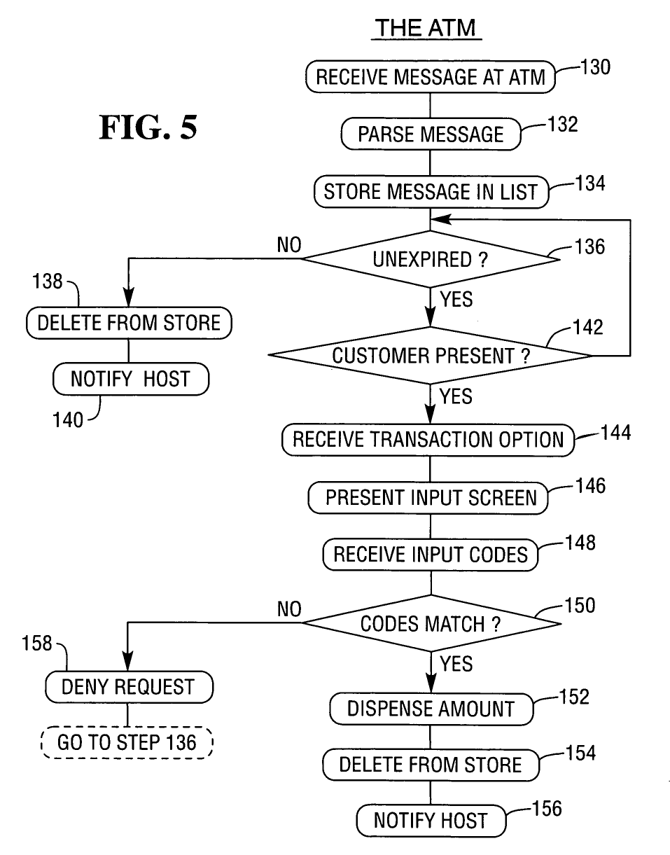

The operation of the ATM 12b will now be described with reference to FIG. 5, which is a flowchart illustrating the steps implemented by the ATM 12b in response to receipt of the pending transaction message.

Initially, the ATM 12b receives the pending transaction message (step 130), parses the message (step 132) to ascertain the lifetime of the transaction (from the lifetime field), and stores the received message (step 134) as an entry in the pending transaction list 28b.

The ATM 12b periodically monitors the pending transaction list 28b to identify any expired transactions (step 136)

If the transaction referenced by the pending transaction message is not executed before expiry of the time limit in the lifetime field then the ATM 12b deletes the pending transaction message (step 138) and notifies the host 14 accordingly (step 140).

If the customer arrives at the ATM 12b prior to expiry of the lifetime of the pending transaction (step 142), then the customer can select an option to execute an approved transaction (step 144). The customer can do this without presenting any token to the ATM 12b because the option is provided as part of a welcome screen on the ATM 12b. Conventional tokens include an ATM card, a credit card, a part of the customer's body (for reading by a biometric reader), a Bluetooth (trade mark) device, or the like.

In response to the customer selecting the option to execute an approved transaction, the ATM 12b presents the customer with an input screen prompting the customer to enter a transaction code and a customer code (in this example, a four digit PIN that the customer uses to access his/her bank account) (step 146).

The customer then enters the transaction code he/she was provided by the Web page 50, that is, “12345”, and his/her PIN (which is a four digit number). The ATM 12b detects these customer entries (step 148).

The ATM 12b then attempts to match the received transaction code (“12345”) with the transaction codes in the pending transaction list. If there is a match, then the ATM 12b ascertains if the entered PIN matches the PIN for the matched entry in the pending transaction list (step 150).

If both the transaction code and the PIN match the corresponding codes in an entry in the pending transaction list, then the transaction is fulfilled (step 152) by the ATM 12b by dispensing fifty dollars (the transaction amount) to the customer. The ATM 12b then deletes the transaction from the pending transaction list (step 154) and notifies the host 14 that the transaction has been executed (step 156), so that the host 14 can delete the transaction from the pending transaction store 26 and debit the amount of money dispensed (fifty dollars) from the customer's account.

If either (i) the received transaction code (“12345”) does not match any of the transaction codes in the pending transaction list, or (ii) the received transaction code does match a transaction code in the list, but the PIN does not match the corresponding code for that entry, then the transaction is not fulfilled by the ATM 12b (step 158). Instead, the ATM 12b returns to step 136, where the ATM 12b periodically monitors the pending transaction list to identify any expired transactions.

It will now be appreciated that this embodiment has the advantage that a customer can enter a transaction for subsequent execution at a selected ATM, and execute that transaction even if the ATM is temporarily offline.

This embodiment has a number of advantages over a conventional transaction where an identification token is required and a real-time authorization is performed with a remote host.

This embodiment is economical because it does not need any new hardware on the ATM. It enables offline transactions to be performed. It speeds up transactions because no remote authorization is required. There is also less traffic between the ATM and the host. ATM availability is improved since no card readers are required to execute these transactions, so even when a card reader is broken or faulty, an ATM can remain in service for this type of transaction.

Various modifications may be made to the above described embodiment within the scope of the invention, for example, in other embodiments, a customer may use the IVR system to request a transaction, or the customer may send a text message or electronic mail message to request a transaction.

In other embodiments, the Web page may be different to that shown. The customer may have to login to the Web site prior to being able to access the Web page shown in FIG. 3 or may have to provide additional security information to request authorization for a transaction. In other embodiments, the Web page may have different fields to those shown, for example, the customer may be allowed to select the lifetime of the transaction.

In other embodiments, the customer's account may be debited when the transaction request is accepted by the host.

In other embodiments, the customer may be allowed to select a transaction code rather than the Web server assigning it to the customer. This allows the customer to select a memorable code for use in executing the transaction. In such embodiments, the acceptance criterion may include confirming that there is no pending transaction with the same transaction code as that requested by the customer.

In other embodiments, the ATM may dispense electronic cash to the customer or some other form of valuable media, such as a ticket.

In other embodiments, an SST other than an ATM may be provided, for example, a ticket issuing kiosk.

In the above embodiment, the customer's PIN was used in the customer verification field. In other embodiments, a different code may be used to increase security and reduce the possibility of the customer's PIN being intercepted.

In other embodiments, a public network (such as the Internet) may be used instead of the private network.

All communications may be encrypted to reduce the possibility of fraud.

In another embodiment, a text message from a cellular telephone may be used to send a transaction authorization request. In such embodiments, the customer may pre-register his/her cellular telephone number with the bank so that the host can identify the customer. When the customer wishes to withdraw cash, the customer sends a text message to a specific telephone number that the bank uses for requesting this type of service. The text message may have the format shown below:
Message Format: <TX><ACCTNUM><AMT><ATMID><CODE>

Where TX is the type of transaction required, such as withdrawal of cash (WDL), cash deposit (DCASH), cheque deposit (DCHK), or the like. ACCTNUM is the number of the customer's account. AMT is the amount of the transaction (for example, thirty dollars). ATMID is the identity of the ATM at which the customer desires to execute this transaction. CODE is an additional customer identification code (such as a four digit code) to verify the identity of the customer.

Once received, the bank will apply an acceptance criterion to this text message (for example, ascertaining if the telephone number and customer identification code pair combination is correct, and ascertaining if the customer has sufficient funds for the requested transaction). If the acceptance criterion is fulfilled, then the bank authorizes the transaction and sends the customer a verification code, for example, as a text message. The customer can visit the ATM identified by the ATMID field within a preset time period (for example, within two hours of sending the text message), and enter the verification code and his PIN. Since the ATM has already received the approval from the host, it will verify the PIN/verification code locally and dispense the requested cash without any delay. This embodiment enables a person to enter a transaction while traveling home from work (for example, on a train) and collect the requested cash at an ATM en route to his/her home.

In other embodiments, different transactions to that shown can be implemented, for example, dispensing stamps.

In other embodiments, the customer's ATM card number may be used as a transaction code so that the customer can enter that number at the selected ATM, or insert the card having that number at the selected ATM, to provide the transaction code to the ATM. Where an integrated circuit card is used, the ATM may update account details (such as the amount of cash withdrawn) stored on the card.

In other-embodiments, a transaction code may be derived from characteristics (a biometric) of the customer. For example, a customer's fingerprint may be used to create the transaction code, so that the customer on arriving at the selected ATM presents his/her finger to a biometric reader at that ATM.

In other embodiments, a customer's card and a biometric reading may be used as the transaction code and customer code.

In other embodiments, a customer may be able to cancel a previously entered transaction request. This cancellation may be made using the same transaction request channel or a different transaction request channel to that used to request the transaction. The host would then inform the selected self-service terminal to remove the transaction from the pending transaction list. Alternatively, the customer may be able to cancel a previously entered transaction request at the terminal storing the transaction request. This terminal would then remove the transaction from the pending transaction list and transmit a transaction cancelled message to the host. The host would then delete the transaction from the pending transaction store and ensure that the customer's account was not debited for that transaction.

In other embodiments, the customer may submit multiple transaction requests to a host in a single session. These requests may be entered individually or concatenated. Examples include dispense fifty dollars, print a cheque for one hundred and sixty dollars, dispense stamps to the value of five dollars, and the like. These requests may be submitted for execution at one terminal, or at a plurality of different terminals, for example, transaction number one at a first terminal, transaction number two at a second terminal, and the like.

In other embodiments, if a selected terminal goes out of service subsequent to the transaction request but prior to transaction fulfillment, then that terminal may inform the host with the change in its state. Either the terminal or the host may provide the customer with an alternative terminal at which the transaction may be executed.

In other embodiments, the terminal may not be a financial terminal, and the transactions may not be related to cash.

1. A transaction authorization method implemented by a self-service terminal, the method comprising:
receiving a transaction message for a preapproved transaction from a host, the transaction message including a transaction identification field, a customer verification field, and a transaction amount field;
storing the received transaction message as an entry in a pending transaction list stored in a computer memory of the self-service terminal;
subsequent to receiving the transaction message, receiving a transaction code and a customer code from a customer locally at the self-service terminal;
controlling a processor to compare the received transaction code and the received customer code with corresponding entries in the transaction message;
controlling the processor to locally examine the transaction message to identify conditions required for executing the transaction; and
controlling the processor to execute the transaction based upon determination that the conditions required for executing the transaction are satisfied without further remote authorization.

2. A method according to claim 1, wherein the step of storing the received transaction message as an entry in a pending transaction list includes the further step of storing the received transaction for a predefined time and ten deleting that entry if not executed prior to expiry of the predefined time.

3. A method according to claim 1, wherein the step of controlling the processor to execute the transaction includes dispensing the transaction amount to the customer in physical cash.

4. A method according to claim 1, wherein the step of controlling the processor to execute the transaction includes dispensing the transaction amount to the customer in electronic cash.

5. A method according to claim 1, wherein the method comprises the further step of transmitting a transaction fulfilled message to the host subsequent to the step of providing the customer with the amount from the transaction amount field.

6. A transaction authorization method comprising: controlling a data processing device so as to present an interface to a user for entry of user selections defining a transaction request for a preapproved transaction specifying details of a transaction to be conducted at a specified self-service terminal remote from the data processing device, the details of the transaction including a transaction amount and an identifier specifying the self-service terminal;
controlling the data processing device to receive user entries specifying the details of the transaction request;
controlling the data processing device to compare selected details of the transaction request against acceptance criteria stored in a memory of the data processing device;
upon verification by the data processing device that the selected details of the transaction request meet the acceptance criteria, controlling the data processing device to prepare a transaction message for the preapproved transaction for transmission to the specified self-service terminal authorizing the self-service terminal to complete the transaction without further remote authorization upon recognition by the self-service terminal of satisfaction of conditions specified in the transaction message.

7. A method according to claim 6, wherein the method comprises the further steps of:
storing the transaction message in a pending transaction store; and
deleting the transaction message from the pending transaction store in response to receipt of a transaction fulfilled message from the self-service terminal.

8. A method according to claim 6, wherein the step of receiving a transaction request from a customer is implemented via a secure channel.

9. A method according to claim 6, wherein the acceptance criteria includes correspondence between a PIN received from the customer and a stored PIN for that customer.

10. A method according to claim 7, wherein the method comprises the further step of debiting the customer's account by an amount equal to the transaction amount.

11. A method according to claim 10, wherein the step of debiting the customer's account is performed when the transaction fulfilled message is received.

12. A system for authenticating transactions at a self-service terminal, the system comprising:
a self-service terminal for receiving a transaction message from a host for a preapproved transaction, the transaction message defining a transaction to be executed by the self-service terminal without further remote authorization upon recognition by the terminal of satisfaction of conditions specified in the transaction message, the transaction message including a transaction identifier and a customer identifier.

13. A system according to claim 12, wherein the transaction identifier comprises a transaction identifier field and a transaction amount field.
